(19) United States
(12) Patent Application Publication
(10) Pub. No.: US 2018/0314457 A1
(43) Pub. Date: Nov. 1, 2018

(54) EXECUTION FRAMEWORK FOR A COMPLEX DATA PROTECTION OPERATION

(71) Applicant: International Business Machines Corporation, Armonk, NY (US)

(72) Inventors: Stefan Bender, Wörrstadt (DE); Mauro Cruciani, Mainz (DE); Avishai H. Hochberg, San Jose, CA (US); Mandeep K. Jandir, San Jose, CA (US); Sean E. Jones, San Antonio, TX (US); Lana Khorosheva, San Jose, CA (US); Joanne T. Nguyen, Saratoga, CA (US); James P. Smith, Redwood City, CA (US); Steven V. Voyk, Austin, TX (US); Martine B. Wedlake, Hillsboro, OR (US); Anthony Wong, San Jose, CA (US); Christopher Zaremba, Endicott, NY (US)

(73) Assignee: International Business Machines Corporation, Armonk, NY (US)

(21) Appl. No.: 15/582,656

(22) Filed: Apr. 29, 2017

(51) Int. Cl. G06F 3/06; G06F 3/0482

(52) U.S. Cl. CPC G06F 3/0647; G06F 3/0619; G06F 3/0482; G06F 3/067; G06F 3/065

(57) ABSTRACT

A method for executing complex data protection operations is disclosed. In one embodiment, such a method includes generating multiple complex data protection operations, where each complex data protection operation includes multiple data protection functions pre-arranged in a specified order and on a specified schedule. The method further presents the multiple complex data protection operations to a user in the form of a menu. This menu includes multiple menu options, where each menu option is associated with one of the complex data protection operations. The method further enables the user to select a menu option, and executes the complex data protection operation associated with the menu option selected by the user. A corresponding system and computer program product are also disclosed.

### BACKGROUND

### Field of the Invention

This invention relates to systems and methods for executing complex data protection operations.

### Background of the Invention

Data is increasingly one of an organization's most valuable assets. Accordingly, it is paramount that an organization protect its data, particularly its business-critical data. Statistics show that a high percentage of organizations, as high as fifty percent, are unable to recover from an event of significant data loss, regardless of whether the loss is the result of a virus, data corruption, physical disaster, software or hardware failure, human error, or the like. At the very least, significant data loss can result in lost income, missed business opportunities, and/or substantial legal liability. Accordingly, it is important that an organization implement adequate policies and procedures to prevent such losses from occurring. In many cases, an organization will protect data using a variety of strategies such as traditional backups, remote data replication, and periodic snapshots. Each of these protection strategies has advantages and disadvantages and uses different techniques to restore lost or damaged data.

In some cases, an administrator may wish to utilize a variety of data protection strategies in a specified order and on a specified schedule. In certain cases, the data protection strategies and associated orders and schedules may be needed to satisfy a service-level-agreement (SLA) or provide desired life cycle management of data. In some cases, data protection strategies that are used may originate from different data protection products which in some cases have different vendors. In any event, selecting a desired set of data protection strategies and executing them in a desired order and on a desired schedule can be a time-consuming and laborious process for a system administrator.

In view of the foregoing, what are needed are systems and methods to execute complex data protection operations made up of multiple data protection functions. Ideally, such systems and methods will simplify the ordering and scheduling of the data protection functions.

### SUMMARY

The invention has been developed in response to the present state of the art and, in particular, in response to the problems and needs in the art that have not yet been fully solved by currently available systems and methods. Accordingly, systems and methods are disclosed for executing complex data protection operations. The features and advantages of the invention will become more fully apparent from the following description and appended claims, or may be learned by practice of the invention as set forth hereinafter.

Consistent with the foregoing, a method for executing complex data protection operations is disclosed. In one embodiment, such a method includes generating multiple complex data protection operations, where each complex data protection operation includes multiple data protection functions pre-arranged in a specified order and on a specified schedule. The method further presents the multiple complex data protection operations to a user in the form of a menu. This menu includes multiple menu options, where each menu option is associated with one of the complex data protection operations. The method further enables the user to select a menu option, and executes the complex data protection operation associated with the menu option selected by the user.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment in which a system and method in accordance with the invention may be implemented;

FIG. 2 is a high-level block diagram showing one example of a storage system in the network environment of FIG. 1;

FIG. 3 is a high-level block diagram showing operation of various data protection functions;

FIG. 4 shows one example of a user interface enabling a user to select from various complex data protection operations;

FIG. 5 shows one example of a user interface enabling a user to select a retention policy;

FIG. 6 shows one example of a user interface enabling a user to select different backup options; and

FIG. 7 shows one example of a user interface enabling a user to review a backup schedule and retention policy.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

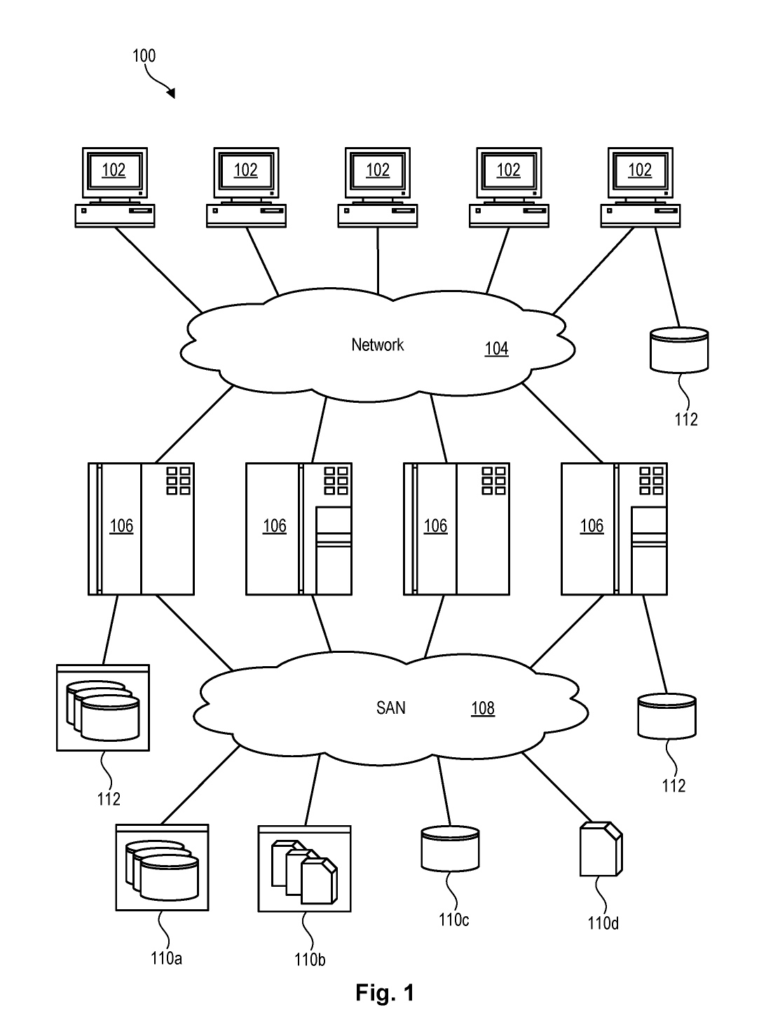

Referring to FIG. 1, one example of a network environment 100 is illustrated. The network environment 100 is presented to show one example of an environment where systems and methods in accordance with the invention may be implemented. The network environment 100 is presented by way of example and not limitation. Indeed, the systems and methods disclosed herein may be applicable to a wide variety of network environments, in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like. One or more of the storage systems 112 may be used in association with the systems and methods disclosed herein.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC). One or more of the storage systems 110 may be used in association with the systems and methods disclosed herein.

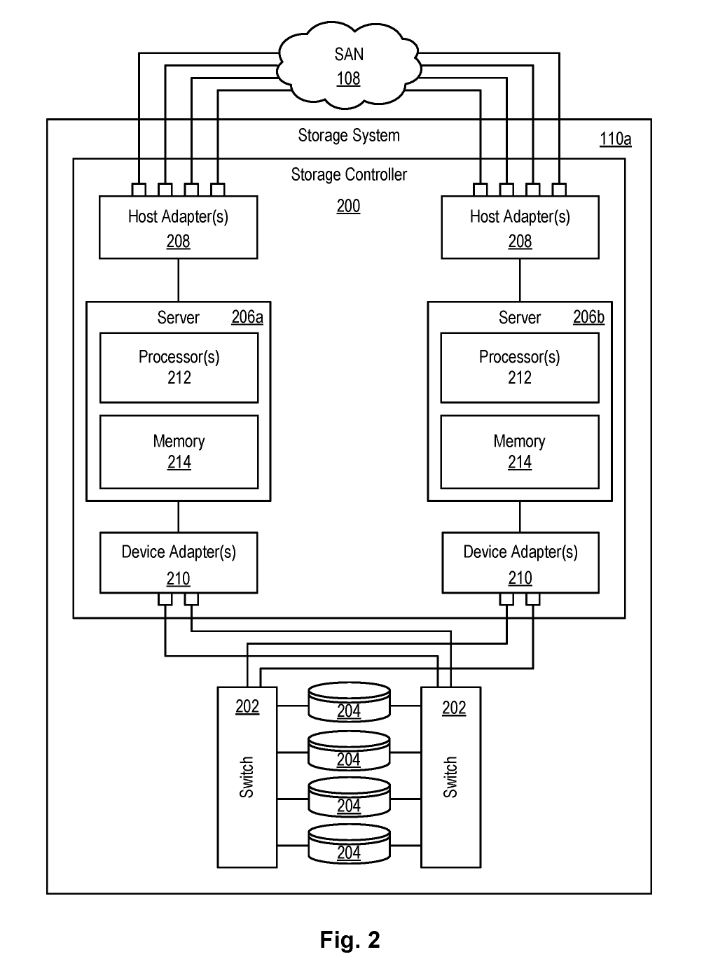

Referring to FIG. 2, one embodiment of a storage system 110a containing an array of hard-disk drives 204 and/or solid-state drives 204 is illustrated. The internal components of the storage system 110a are shown since functionality in accordance with the invention may be implemented within such a storage system 110a. As shown, the storage system 110a includes a storage controller 200, one or more switches 202, and one or more storage devices 204, such as hard disk drives 204 or solid-state drives 204 (such as flash-memory-based drives 204). The storage controller 200 may enable one or more hosts 106 (e.g., open system and/or mainframe servers 106) to access data in the one or more storage devices 204.

In selected embodiments, the storage controller 200 includes one or more servers 206. The storage controller 200 may also include host adapters 208 and device adapters 210 to connect the storage controller 200 to host devices 106 and storage devices 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage devices 204. This process may be referred to as a “failover.”

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage devices 204. These software modules may manage all read and write requests to logical volumes in the storage devices 204.

One example of a storage system 110a having an architecture similar to that illustrated in FIG. 2 is the IBM DS8000™ enterprise storage system. The DS8000™ is a high-performance, high-capacity storage controller providing disk storage that is designed to support continuous operations. Nevertheless, the systems and methods disclosed herein are not limited to the IBM DS8000™ enterprise storage system 110a, but may be implemented in any comparable or analogous storage system 110, regardless of the manufacturer, product name, or components or component names associated with the system 110. Furthermore, any storage system that could benefit from one or more embodiments of the invention is deemed to fall within the scope of the invention. Thus, the IBM DS8000™ is presented only by way of example and is not intended to be limiting.

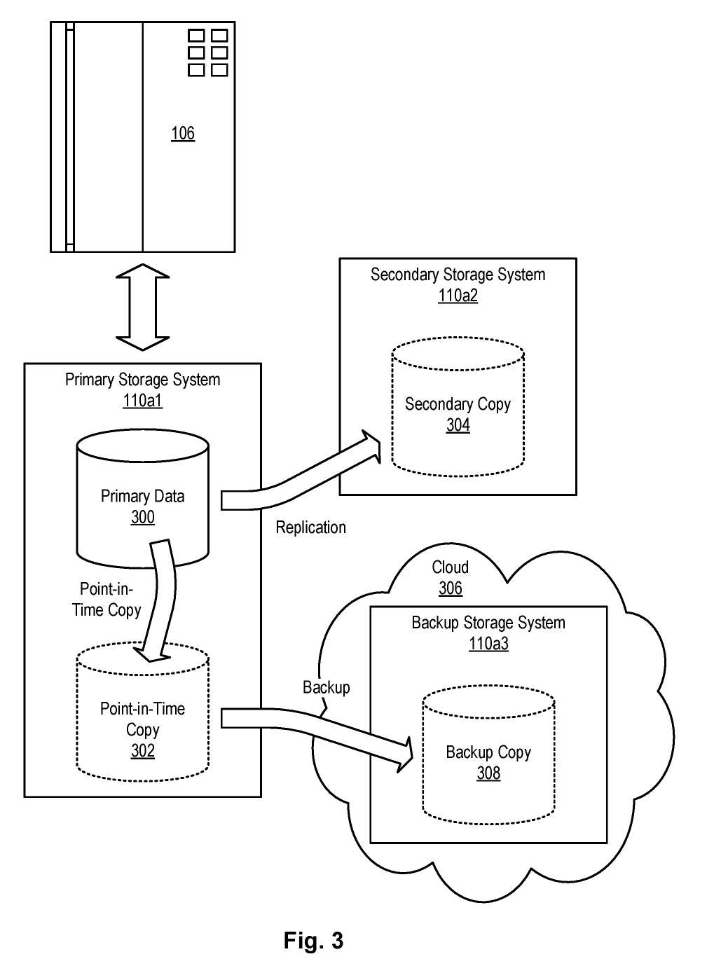

Referring to FIG. 3, in some cases, an administrator may utilize one or more data protection functions to protect data residing on a storage systems 110. Such data protection functions may include, for example, creating snapshots (point-in-time copies) of data, backing up data, archiving data, replicating data, or the like. Each of these data protection functions may have advantages and disadvantages and may be executed alone or in combination. In certain cases, a data protection strategy may require executing multiple data protection functions in a desired order and on a desired schedule. For example a first data protection function may generate a point-in-time copy of selected data. A second data protection function may back up data in the point-in-time copy to another location.

FIG. 3 is a high-level block diagram showing different exemplary data protection functions. For example, a replication data protection function may synchronously or asynchronously replicate primary data 300, residing on a primary storage system 110a1, to a secondary storage system 110a2. This may create a secondary copy 304 of the primary data 300 on the secondary storage system 110a2. In the event the primary storage system 110a1 fails or experiences an outage, a host system 106 may swap I/O to the secondary copy 304 on the secondary storage system 110a2 to provide substantially continuous data availability.

A point-in-time-copy data protection function may generate a point-in-time copy 302 of the primary data 300. This point-in-time copy 302 may reside on the same storage system 110a1 as the primary data 300 or be generated on a different storage system 110. In certain cases, a backup data protection function may back up data in the point-in-time copy 302 instead of the primary data 300 to reduce the I/O workload on the primary data 300 and/or ensure that the backup contains data associated with a certain point in time. For example, a backup data protection function may copy data in the point-in-time copy 302 to a backup storage system 110a3, such as a cloud-based backup storage system 110a3. This may create a backup copy 308 of the point-in-time copy 302. In this example, the backup data protection function relies on completion of the point-in-time copy 302 data protection function, thus requiring a specified order of completion.

The data protection functions illustrated in FIG. 3 are provided by way of example and not limitation. Other data protection functions are possible and within the scope of the invention.

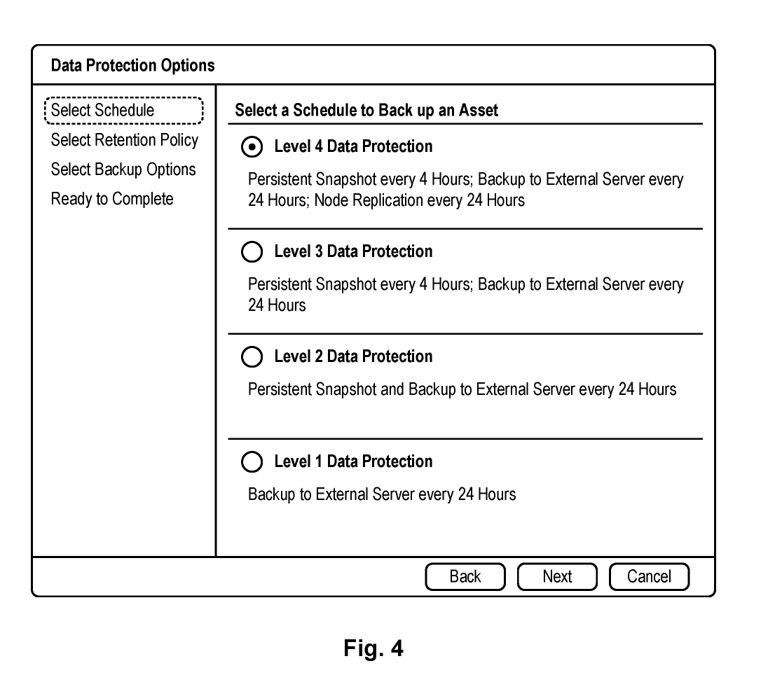

Referring to FIG. 4, in certain cases, an administrator may want to utilize a variety of data protection functions in a specified order and on a specified schedule. In certain cases, the data protection functions and associated orders and/or schedules may be needed to satisfy a service-level-agreement (S LA) or provide desired life cycle management of data. In any event, selecting a desired set of data protection functions and executing then in a desired order (due to dependencies, etc.) and schedule can be a time-consuming and laborious process for a system administrator.

FIG. 4 shows one example of a user interface enabling a user to select from various complex data protection operations to protect primary data 300. One or more of the complex data protection operations may include multiple data protection functions pre-arranged in a specified order and on a specified schedule. This eliminates or reduces the need for an administrator to manually assemble data protection functions and specify a schedule and/or order of execution.

As shown in FIG. 4, the complex data protection operations may be presented to a user in the form of a menu having multiple menu options. In the illustrated example, the menu options include “Level 4 data protection,” “Level 3 data protection,” “Level 2 data protection,” and “Level 1 data protection.” Level 4 data protection generates a persistent snapshot of primary data 300 every four hours, backs up the persistent snapshot to an external (e.g., offsite) server every twenty-four hours, and replicates the primary data 300 every twenty-four hours. Level 3 data protection, by contrast, generates a persistent snapshot of primary data 300 every four hours and backs up the persistent snapshot to an external server every twenty-four hours. Level 2 data protection generates a persistent snapshot of primary data 300 every twenty-four hours and backs up the persistent snapshot to an external server every twenty-four hours. Level 1 data protection, in this example the lowest level of data protection, backs up the primary data 300 to an external server every twenty-four hours.

The user interface shown in FIG. 4 enables an administrator to select a menu option from the list. Once a menu option is selected, systems and methods in accordance with the invention will execute the data protection functions associated with the menu option in the order/schedule that is specified. This may be accomplished by issuing commands to the different data protection functions (which may originate from different products with potentially different vendors) at the appropriate times/intervals. This greatly simplifies creation of a complex data protection strategy made up of multiple data protection functions.

The levels of data protection shown in FIG. 4 are presented by way of example and may be modified as needed to include other data protection functions, orders, or schedules (e.g., specific days/times or intervals of operation). Data protection functions may include, for example, an initial full backup, a periodic incremental backup, a periodic snapshot, a periodic full backup, archival to another server, data replication, migration or backup to a cloud server, or the like. In certain embodiments, systems and methods in accordance with the invention may be configured to execute a discovery process to determine which data protection functions are available and automatically include these data protection functions, either alone or in combination, as menu options. This may be accomplished, for example, by querying hardware directly or by querying an intermediary entity such as Microsoft Volume Shadow Copy Services (VSS). Thus, a menu presented to an administrator may vary based on the data protection functions that are available.

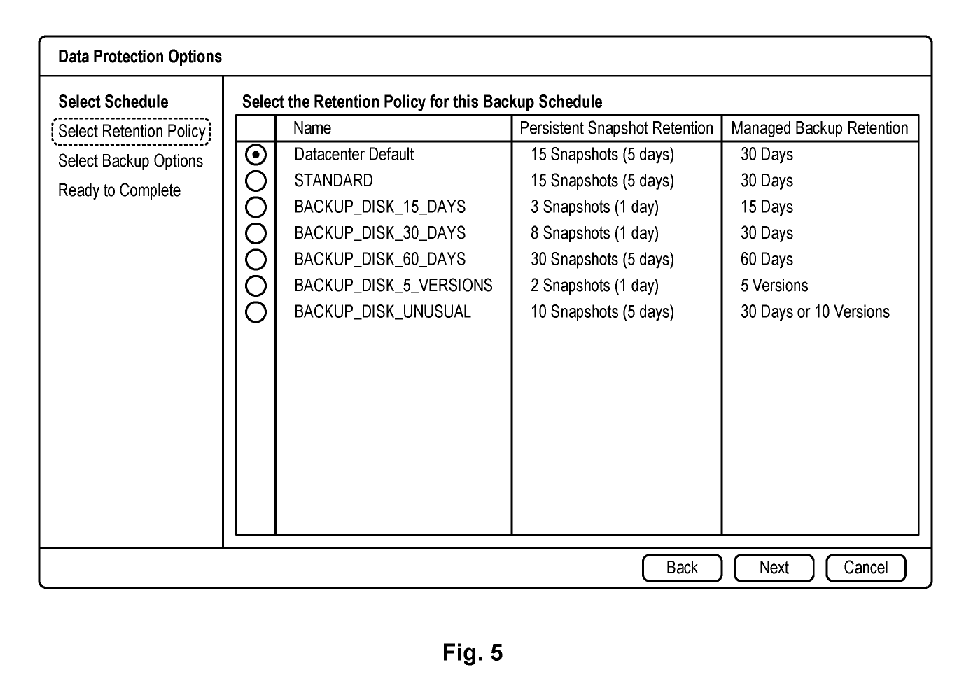

Referring to FIG. 5, one example of a user interface to enable an administrator to select a retention policy is illustrated. As shown, once an administrator selects a menu option associated with a complex data protection operation, the administrator may select a retention policy to be used in association with the complex data protection operation. For example, an administrator may desire to retain a specified number of snapshots (point-in-time copies) before beginning to delete snapshots. Similarly, the administrator may desire to keep a backup for a specified amount of time prior to deleting the backup, or alternatively retain a specified number of backup copies or versions prior to deleting backups. The user interface shown in FIG. 5 enables the administrator to select a desired retention policy by selecting from the list.

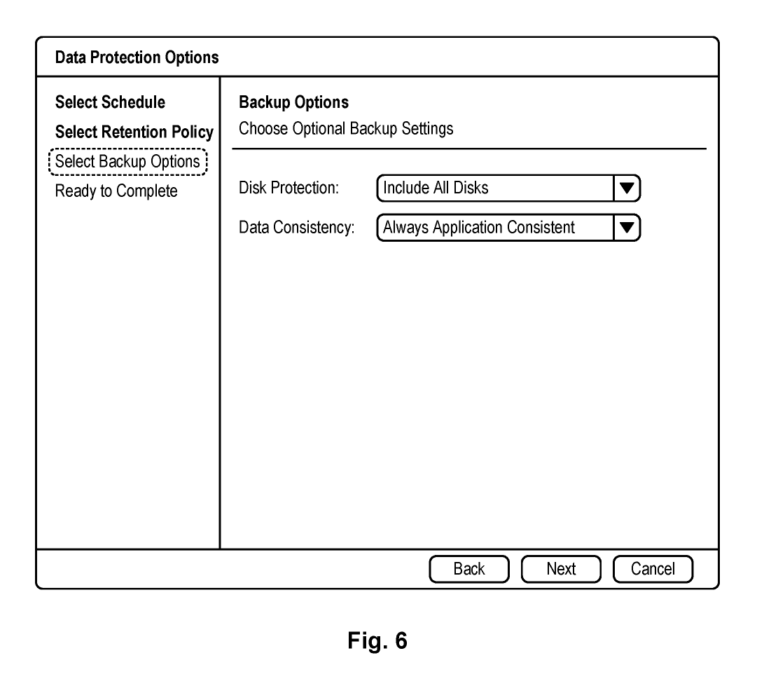

Referring to FIG. 6, one example of a user interface enabling a user to select different backup options is illustrated. As shown, once an administrator selects a complex data protection operation and a desired retention policy, the administrator may select from various backup options for use in association with the complex data protection operation. For example, an administrator may desire that disk protection include all disks or that data consistency always be application consistent. The user interface may enable an administrator to select these options using, for example, the pull down menus shown in FIG. 6.

Other settings are also possible. For example, a user interface (not shown) may enable an administrator to establish a retry policy to determine what to do in failure situations. For example, if a snapshot data protection function fails, the data protection function may be retried up to a certain number times. Similarly, if a snapshot data protection function succeeds but an associated backup function fails, the system may continue processing but issue a warning. Alternatively, if a snapshot data protection function succeeds but an associated backup function fails, the system may retry the complex data protection operation but fall back to a previous policy if the complex data protection operation fails. These represent just a few examples of retry policies. Other retry policies are possible and within the scope of the invention.

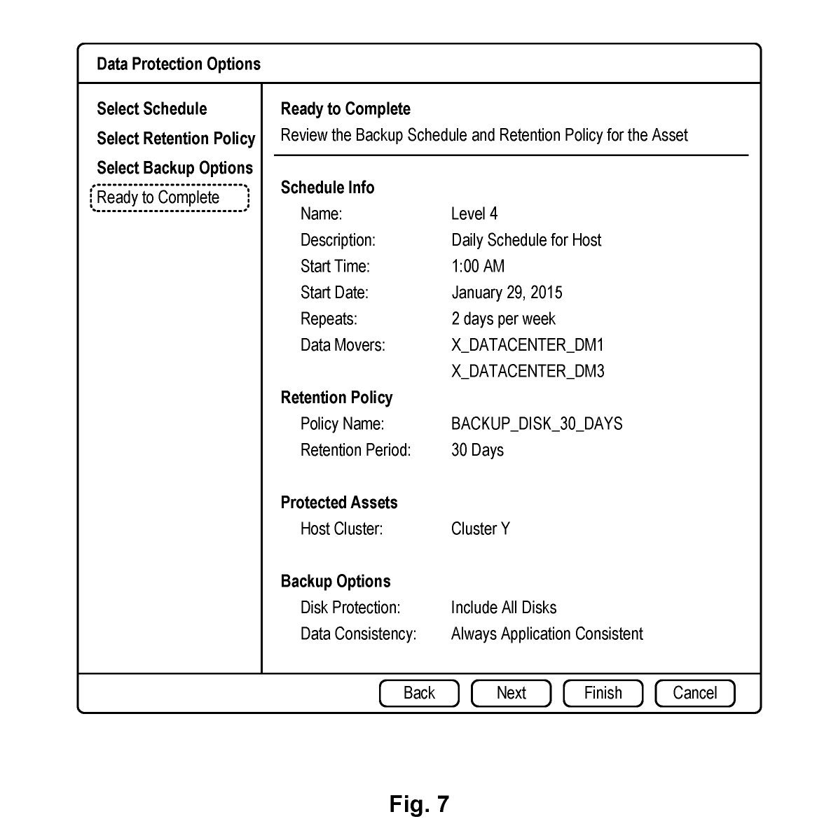

Referring to FIG. 7, one example of a user interface enabling a user to review a backup schedule and retention policy is illustrated. As shown, once an administrator selects a complex data protection operation, desired retention policy, and backup options, a user interface may display the backup schedule and retention policy for confirmation. In particular, the user interface may enable the user to review the schedule associated with the complex data protection operation, the retention policy, assets that are being protected by the complex data protection operation, and backup options that have been selected. If each of these is accurate, the administrator may complete and confirm the complex data protection operation.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for executing complex data protection operations, the method comprising:
generating a plurality of complex data protection operations, wherein each complex data protection operation comprises multiple independent data protection functions pre-arranged in a specified order and on a specified schedule;
presenting the plurality of complex data protection operations to a user in the form of a menu comprising multiple menu options, wherein each menu option is associated with one of the plurality of complex data protection operations;
enabling the user to select a menu option from the menu; and
executing the complex data protection operation associated with the menu option selected by the user.

2. The method of claim 1, wherein the independent data protection functions are selected from the group consisting of: an initial full backup, a periodic incremental backup, a periodic snapshot, a periodic full backup, archival to another server, data replication, and migration to a cloud server.

3. The method of claim 1, further comprising executing a discovery process to determine which independent data protection functions are available for inclusion in the complex data protection operations.

4. The method of claim 1, further comprising enabling a user to designate a retention policy for at least one of the independent data protection functions.

5. The method of claim 1, further comprising enabling a user to designate actions to be taken in the event at least one of the independent data protection functions fails.

6. The method of claim 1, wherein each of the multiple independent data protection functions are provided by a different data protection product.

7. The method of claim 1, wherein at least one independent data protection function associated with a complex data protection operation is configured to prepare data for at least one other independent data protection function associated with the complex data protection operation.

8. A computer program product for executing complex data protection operations, the computer program product comprising a computer-readable storage medium having computer-usable program code embodied therein, the computer-usable program code configured to perform the following when executed by at least one processor:
generate a plurality of complex data protection operations, wherein each complex data protection operation comprises multiple independent data protection functions pre-arranged in a specified order and on a specified schedule;
present the plurality of complex data protection operations to a user in the form of a menu comprising multiple menu options, wherein each menu option is associated with one of the plurality of complex data protection operations;
enable the user to select a menu option from the menu; and
execute the complex data protection operation associated with the menu option selected by the user.

9. The computer program product of claim 8, wherein the independent data protection functions are selected from the group consisting of: an initial full backup, a periodic incremental backup, a periodic snapshot, a periodic full backup, archival to another server, data replication, and migration to a cloud server.

10. The computer program product of claim 8, wherein the computer-usable program code is further configured to execute a discovery process to determine which independent data protection functions are available for inclusion in the complex data protection operations.

11. The computer program product of claim 8, wherein the computer-usable program code is further configured to enable a user to designate a retention policy for at least one of the independent data protection functions.

12. The computer program product of claim 8, wherein the computer-usable program code is further configured to enable a user to designate actions to be taken in the event at least one of the independent data protection functions fails.

13. The computer program product of claim 8, wherein each of the multiple independent data protection functions are provided by a different data protection product.

14. The computer program product of claim 8, wherein at least one independent data protection function associated with a complex data protection operation is configured to prepare data for at least one other independent data protection function associated with the complex data protection operation.

15. A system for executing complex data protection operations, the system comprising:
at least one processor;
at least one memory device operably coupled to the at least one processor and storing instructions for execution on the at least one processor, the instructions causing the at least one processor to:
generate a plurality of complex data protection operations, wherein each complex data protection operation comprises multiple independent data protection functions pre-arranged in a specified order and on a specified schedule;
present the plurality of complex data protection operations to a user in the form of a menu comprising multiple menu options, where each menu option is associated with one of the plurality of complex data protection operations;
enable the user to select a menu option from the menu; and
execute the complex data protection operation associated with the menu option selected by the user.

16. The system of claim 15, wherein the independent data protection functions are selected from the group consisting of: an initial full backup, a periodic incremental backup, a periodic snapshot, a periodic full backup, archival to another server, data replication, and migration to a cloud server.

17. The system of claim 15, wherein the instructions further cause the at least one processor to execute a discovery process to determine which independent data protection functions are available for inclusion in the complex data protection operations.

18. The system of claim 15, wherein the instructions further cause the at least one processor to enable a user to designate a retention policy for at least one of the independent data protection functions.

19. The system of claim 15, wherein each of the multiple independent data protection functions are provided by a different data protection product.

20. The system of claim 15, wherein at least one independent data protection function associated with a complex data protection operation is configured to prepare data for at least one other independent data protection function associated with the complex data protection operation.
